(19) United States
(12) Patent Application Publication
(10) Pub. No.: US 2024/0308130 A1
(43) Pub. Date: Sep. 19, 2024

(54) PERFORATED LINER

(71) Applicant: SAERTEX multiCom GmbH, Saerbeck (DE)

(72) Inventors: Nils Füchtjohann, Greven (DE); Christoph Feldbrügge, Münster (DE)

(21) Appl. No.: 18/581,107

(22) Filed: Feb. 19, 2024

(30) Foreign Application Priority Data
Mar. 16, 2023 (EP) 23162294.5

(51) Int. Cl. B29C 63/34; B29C 70/22; B29K 105/10; B29L 23/00

(52) U.S. Cl. CPC B29C 63/34; B29C 70/22; B29C 2793/0063; B29C 2793/0072; B29K 2105/101; B29L 2023/001

(57) ABSTRACT

A tubular liner for the rehabilitation of pipelines or canals, a cured liner, a process for manufacturing a liner, the use of said liner, a process for rehabilitating pipelines or canals and a rehabilitated pipeline or a rehabilitated canal, respectively. The tubular liner includes resin-impregnated fibrous layers, wherein at least one of the resin-impregnated fibrous layers is a transverse fibrous layer which mainly includes fibres arranged at an angle in a range from 45 degrees to 135 degrees with respect to the longitudinal direction of the tubular liner.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The invention pertains to a tubular liner for the rehabilitation of pipelines and canals, a cured liner, a process for manufacturing a liner, the use of said liner, a process for rehabilitating pipelines and canals and a rehabilitated pipeline or canal, respectively.

### BACKGROUND

Most solutions for tubular liners for the rehabilitation of pipelines or canals describe fibrous layers with randomly arranged fibres (nonwoven fabrics or chopping rovings, for example) or fibres arranged in the longitudinal direction of the liner to improve the mechanical parameters in the longitudinal direction or the stability required for pull-in liners. Generally, fibres can be oriented in the circumferential direction, that is, perpendicular to the longitudinal direction of the liner, for improving the mechanical parameters of the liner in the circumferential direction. Up to now, either very short fibre sections usually laid overlapping have been oriented in the circumferential direction. Often, such liners have a longitudinal seam which deteriorates their stretchability in the circumferential direction. Or, continuous fibres extending essentially around the complete circumference of the liner have been oriented in the circumferential direction. Up to now, in these solutions the outermost mat had to be connected at the longitudinal edge. Consequently, stretchability in the circumferential direction was restricted in these solutions. These solutions are disadvantageous in that the liner will stretch less or not at all when inflated in the pipeline to be rehabilitated, resulting in the cured liner not properly resting against the old pipe.

### SUMMARY

Accordingly, it is the object of the present invention to overcome the drawbacks of the state of the art and to provide a technology which allows to obtain liners having good mechanical parameters also in the circumferential direction and still a sufficient stretchability for resting better against the old pipe of the pipe to be rehabilitated.

In a first embodiment, the object of the invention is achieved by a tubular liner for the rehabilitation of pipelines and canals that comprises resin-impregnated fibrous layers, wherein at least one fibrous layer is a transverse fibrous layer which (mainly) comprises fibres arranged at an angle in a range from 45 degrees to 135 degrees with respect to the longitudinal direction of the liner, wherein the fibres of the transverse fibrous layer arranged in this way mainly have a median length in a range from 10 to 55%, particularly preferably from 20 to 50% of the liner circumference.

Several layers may form a mat. For example, a mat may be formed from a direct roving layer, a transverse fibrous layer and a chopping roving layer. These layers may be sewn to one another.

On the one hand, the liner according to the invention has the advantage that it is more flexible and less working pressure is required. Within the meaning of the invention, the working pressure is the pressure maintained during installation for pressing the liner against the old pipe. On the other hand, due to its increased flexibility the liner has the advantage that side branches such as house connections, for example, can be recognised (“dimpling”) and hence identified more easily in the rehabilitated pipe.

Within the meaning of the invention, the term “mainly” means more than 50% by weight when referring to mass data.

Within the meaning of the invention, “exterior” means facing the inner pipe wall of the pipeline or canal to be rehabilitated. Within the meaning of the invention, “inner” means facing the inner pipe wall of the pipeline or canal to be rehabilitated. This is important, as there are so-called pull-in liners, for example, the outermost layer of which is at the outside before and after installation. However, there are also so-called inversion liners wherein a previously internal inner layer is arranged outwardly in the rehabilitated pipeline or canal.

### Liner Layers

The liner may comprise at least one exterior layer (light protection film, exterior film, . . . , for example). The exterior layer may comprise a monomer barrier layer. This monomer barrier layer is to prevent the diffusion of reactive diluents such as styrene, for example, from the uncured resin system. The exterior layer preferably has a thickness in a range from 40 to 2000 μm. Advantageously, the exterior layer is impermeable to UV radiation to prevent the resin system in the resin-impregnated fibrous layer from curing during storage or transport, for example. The exterior layer can consist of a polymer or also of a nonwoven fabric lined with a polymer, for example. Polyester, polyamide, polyvinyl chloride, polyacrylonitrile, polyethylene, polypropylene and/or mixtures thereof are suitable as a material for the polymer and/or the nonwoven fabric.

The liner may also comprise at least one anchor layer. The anchor layer that preferably consists of a thermoplastic material has again preferably a thickness in a range from 10 to 5000 μm, especially from 30 to 500 μm. The anchor layer advantageously consists of a nonwoven fabric or a melt adhesive or a combination of these variants. Exceptionally preferably, the nonwoven fabric consists of glass, thermoplastic materials, PAN or mixtures thereof. The thermoplastic materials are selected from polyethylene, polypropylene or polyester, for instance. The melt adhesive is a polyamide, polyethylene, APAO (amorphous polyolefin), EVAC (ethylene-vinyl acetate copolymer), TPE-E (polyester elastomer), TPE-U (polyurethane elastomer), TPE-A (copolyamide elastomer) or a vinylpyrrolidone/vinyl acetate copolymer and mixtures thereof, for example.

The liner may comprise an inner layer. The inner layer may comprise a monomer barrier layer. The inner layer advantageously has a thickness in a range from 100 to 1500 μm. In particular, the inner layer has a thickness in a range from 100 to 600 μm. On the one hand, this allows to protect said inner layer against mechanical damage by the device for curing the resin-impregnated fibrous layer, for example, on the other hand, it is still thin enough to allow the transmission of heat or UV radiation sufficient for curing. This inner layer advantageously has several layers. One of these layers is a monomer barrier layer, for example. This monomer barrier layer is to prevent the diffusion of reactive diluents such as styrene, for example, from the uncured resin system. Advantageously, this monomer barrier layer is one of the layers of the inner layer that is not arranged externally (here, “externally” means “visible for the viewer” and/or “adjacent to the anchor layer”). For example, the monomer barrier layer contains at least 50% by weight and in particular, preferably, consists of polyamide, ethylene-vinyl alcohol copolymer, PBT, PET, halogenated polymers or mixtures thereof. Particularly preferably, the monomer barrier layer consists of one or several of these materials. The monomer barrier layer advantageously has a thickness in a range from 10 to 500 μm.

The inner layer advantageously has at least one and advantageously two external layers (here, “external” means “visible for the viewer” and/or “adjacent to the anchor layer”) made of polyurethane, polyethylene or polypropylene. This external layer advantageously has a thickness in a range from 50 to 1000 μm. For example, the external layer adjacent to the anchor layer (when serving as a bonding layer, for example) may be thinner than the other external layer facing the centre of the tube (namely a wear layer, for example). This allows the inner layer to provide an even better protection against mechanical effects.

Preferably, at least the anchor layer and the inner layer are interconnected in a non-positive and/or positive-fit manner. Since at least these two layers are preferably interconnected in a non-positive and/or positive-fit manner, they cannot move relative to each other in the. This substantially improves the stability of the complete layer structure. Moreover, the inner layer is substantially strengthened by the anchor layer connected therewith, preventing the inner layer from being damaged easily.

Within the meaning of the invention, “in a non-positive and/or positive-fit manner” can advantageously mean that the respective layers are lined, laminated, adhesively bonded to one another either over the entire surface or partially. If the layers are partially connected to one another, at least 40% of the layer surfaces are preferably connected to one another or alternatively connected at certain points. Hence, a slippage of the layers against each other can be avoided completely. Additionally or alternatively, the layers may also be connected by extruding a highly flowable thermoplastic material between the layers during manufacture.

Preferably, on the very inside towards the centre of the pipe a layer made of polyethylene, polypropylene or polyurethane is arranged as the external layer of the inner layer. Advantageously, the monomer barrier layer as a layer of the inner layer is arranged adjacent thereto. Advantageously, a polyethylene or polypropylene layer as an additional layer of the inner layer may be provided between the anchor layer and the monomer barrier layer.

The liner may comprise several fibrous layers, at least one thereof being a transverse fibrous layer.

### Fibrous Layers

The fibres may preferably be fibres made of glass, carbon, polymer, cellulose or mixtures thereof, very particularly preferably, however, glass.

The fibrous layers or at least one fibrous layer, at least, may consist of material sheets connected to one another at their longitudinal edges. This connection can be carried out by sewing or needle punching, for example. Thus, tubular fibrous layers can be formed. However, the fibrous layers may also simply be laid in an overlapping configuration without being connected in the overlapping area, thus forming a tubular structure. Preferably, the longitudinal edges of the outermost fibrous layer facing the inner pipe wall are connected to one another (by overlapping and then by needle punching, for example). Moreover, at least one mat may be connected to itself along its longitudinal edge. Preferably, the longitudinal edges of the outermost mat facing the inner pipe wall are connected to one another (by overlapping and then by needle punching, for example). A mat may comprise several fibrous layers. Said fibrous layers may be transverse fibrous layers, direct roving layers or chopping roving layers. Also, a mat may consist of at least one material sheet, wherein the material sheet may comprise several fibrous layers.

The adjacent fibrous layers or also adjacent mats may differ from each other in that the longitudinal edges of the material sheets are offset.

For example, the fibres may consist of filament bundles.

The fibrous layer is preferably a scrim, a fabric, a random laid mat, a weft knit fabric, a nonwoven fabric, a felt, a knitted fabric or a combination or a multi-layer structure of these textile fabrics. A transverse fibrous layer may also comprise chopping roving in the same layer, for example. A fibrous layer may also comprise several fibre types (polymer fibres, glass fibres, carbon fibres, . . . , for example). For example, within one layer a nonwoven fabric may be combined with a scrim.

The mats may preferably each have a weight per unit area in a range from 200 to 3000 g/m², more preferably in a range from 400 to 2600 g/m² and very particularly preferably in a range from 700 to 1800 g/m². The fibrous layers may preferably each have a weight per unit area in a range from 50 to 1000 g/m², more preferably in a range from 100 to 900 g/m² and very particularly preferably in a range from 200 to 600 g/m².

Preferably, the liner may comprise from 1 to 20 mats, particularly preferably from 2 to 15 mats. Preferably, the liner may comprise from 3 to 60 fibrous layers, particularly preferably from 6 to 45 fibrous layers.

The material for the resin system may be selected from the group of unsaturated polyester resins, vinyl ester resins, epoxy resins or mixtures thereof.

The resin system in the resin-impregnated fibrous layer is preferably not or only partially through-polymerised (prior to installation). The resin can be through-polymerised after installation. The composition of the resin system advantageously contains from 0.1 to 20 parts by weight of a thickener (such as, for example, isocyanate, metal hydroxides, metal oxides such as magnesium oxide or calcium oxide, for example, or mineral substances such as kaolin, for example, or mixtures thereof) and in particular an isocyanate, based on 100 parts by weight of the resin system. It has turned out that this results in a sufficient thickening of the composition of the resin system in the application for rehabilitating pipes, however, it is sufficiently liquid during manufacture to provide a complete impregnation of the anchor layer or the inner nonwoven fabric and the fibrous layer.

At least the fibrous layer or mat at the extreme outside is preferably connected along the longitudinal edge (overlapping and needle-punched or adhesively bonded or quilted or sewn, for example). Preferably, the mat at the extreme outside comprises a needle-punched scrim. The mat at the extreme outside can, but does not have to comprise a transverse fibrous layer.

### Transverse Fibrous Layer

At least one of the fibrous layers is a transverse fibrous layer.

The at least one transverse fibrous layer preferably (mainly) differs from an adjacent fibrous layer by the arrangement of fibres, the material of the fibres, the median of the fibre length and/or the weight per unit area of adjacent layers. The at least one transverse fibrous layer can also differ from an adjacent fibrous layer in that the connection or overlapping (or also overlapping and connection) of the longitudinal edges of the material sheets is offset in the circumferential direction.

Preferably, the transverse fibrous layer mainly comprises (particularly preferably at least 60% by weight of) fibres arranged at an angle in a range from 60 degrees to 120 degrees, particularly preferably from 80 degrees to 100 degrees, with respect to the longitudinal direction of the liner. The weight per unit area of these fibres in the transverse fibrous layer can preferably be in a range from 50 to 1000 g/m².

The transverse fibrous layer or also the mat may also comprise fibres arranged at an angle from +20 degrees to −20 degrees with respect to the longitudinal direction. The weight per unit area of these fibres in the transverse fibrous layer or mat can preferably be in a range from 50 to 1000 g/m².

The transverse fibrous layer or mat may also contain chopping roving (CSM, for example). The weight per unit area of these fibres in the transverse fibrous layer or mat can preferably be in a range from 50 to 1000 g/m².

The transverse fibrous layer or mat can preferably comprise a scrim. Preferably, the scrim has a width in a range from 90 to 110% of the liner circumference. Preferably, the scrim has the length of the liner. Alternatively and in particular with very long liners, however, the liner may also consist of several connected scrims. Preferably, the scrim is connected to itself at both longitudinal edges of the scrim (by sewing or needle punching, either edge-to-edge or overlapping), especially when it is the outermost transverse fibrous layer. This results in a tubular transverse fibrous layer or mat.

Preferably, at least one transverse fibrous layer mainly comprises (particularly preferably at least 50% by weight, very particularly preferably at least 60% by weight of) fibres arranged at an angle in a range from 45 degrees to 135 degrees with respect to the longitudinal direction of the liner and wherein said fibres are severed at at least one point, preferably at at least 2 points, more preferably at 1 to 10 points per fibre. Preferably, the distance of these points of severing to the fibre end is in a range from 5 to 100 cm, particularly preferably in a range from 10 to 50 cm. Preferably, the distance of these points of severing to the fibre end is in a range from 2 to 20% of the liner circumference, particularly preferably in a range from 5 to 15% of the liner circumference. Alternatively, the distance of these points of severing to the fibre end or the adjacent point of severing is at least a =(circumference/(number+1))−40%, wherein the circumference is the circumference of the liner and the number is the number of points of severing. The severings (cuts, for example) can also be randomly orientated and have a random length. The number of severings per area and the length of the severings meet their limits when the material can no longer be processed. Preferably, the severings (such as cuts, for example) are grouped. Preferably, the fibres of the transverse fibrous layer are severed by cuts in the longitudinal direction of the liner having a length of from 0.5 to 50 cm, respectively. For example, the fibres of the transverse fibrous layer are severed over a length of from 0.5 to 50 cm, particularly preferably of from 2 to 10 cm, by cuts in the longitudinal direction of the liner at the same location in the circumferential direction, for example. At the same location in the circumferential direction means that there is virtually a cutting line in the longitudinal direction of the liner with cuts lying on this cutting line. For example, this can be achieved with punching dies which are lowered into the fibres together with the cutting tool and then removed from the fibres. This can be carried out by cuts through the fibres of the transverse fibrous layer in the longitudinal direction of the liner, for example. The severings or cuts can be arranged along one or several cutting lines which preferably extend in the longitudinal direction of the liner (the cutting lines may also have another angle). Along one cutting line, the fibres of the transverse fibrous layer may be severed by cuts arranged evenly or unevenly. Adjacent cuts having the same cutting length are preferably spaced from each other by one spacing. The median of the spacing of the cuts along one cutting line is preferably shorter than the median of the cutting length of the cuts. The median of the spacing is preferably in a range from 20 to 70% of the median of the cutting length. The positions in the circumferential direction of the severings (or cuts) of the groups of severings adjacent in the longitudinal direction of the liner preferably have a distance of from 10 to 40% of the liner circumference. The number of cutting lines in the longitudinal direction of the liner is preferably in a range from 1 to 12, very particularly preferably in a range from 2 to 6. These features describing the fibrous layer, in particular those pertaining to severing, can also apply to a mat. Hence, also a mat consisting of several fibrous layers can also have severings.

Preferably, the cutting lines do not extend in a folding edge in the longitudinal direction of the liner.

The at least one transverse fibrous layer can but does not have to be the outermost fibrous layer. Additionally or alternatively, a transverse fibrous layer may be one of the other fibrous layers of a mat.

Preferably, the transverse fibrous layer comprises at least 50% by weight, particularly preferably at least 60% by weight of fibres arranged at an angle in a range from 45 degrees to 135 degrees, particularly preferably from 80 degrees to 100 degrees, with respect to the longitudinal direction of the liner.

Preferably, also the transverse fibrous layer is resin-impregnated.

### Further Embodiments

In another embodiment, the object of the invention is achieved by a cured liner characterised in that the resin system of the resin-impregnated liner according to the invention is cured.

Within the meaning of the invention, “cured” can refer to the residual styrene content being below 10% by weight, based on the pure resin, for example.

In another embodiment the object of the invention is achieved by a process for manufacturing the liner according to the invention, wherein the process comprises at least the following steps:
a. Providing at least one material sheet containing fibres for manufacturing a fibrous layer,
b. Providing at least one additional material sheet for manufacturing a transverse fibrous layer which mainly comprises fibres arranged at an angle in a range from 45 degrees to 135 degrees with respect to the longitudinal direction of the material sheet wherein the fibres arranged in such a way are mainly at least as long as the material sheet is wide,
c. Making cuts in the additional material sheet, wherein the fibres of the additional material sheet are severed such that said fibres of the additional material sheet arranged at the above-mentioned angle mainly have a median length in a range from 10 to 50% of the width of the material sheet,
d. Connecting the longitudinal edges of at least one of the material sheets such that this material sheet becomes a tubular fibrous layer, wherein the additional material sheet becomes the transverse fibrous layer and the formed tubular fibrous layers are arranged in one another,
e. Impregnating the fibrous layers with a resin system.

A transverse fibrous layer can already be formed in step a.

In step c., the cuts preferably can be made in the longitudinal direction of the liner. However, they can also be made in a different direction.

In step d., the longitudinal edges of the additional material sheet can be connected by sewing or needle punching, for example. The longitudinal edges can be connected in an overlapping manner or edge-to-edge. The dry liner material can be formed by connecting the longitudinal edges, for example.

Additional layers such as the exterior layer or the inner layer can be added in order to obtain the final liner according to the invention. Preferably, the inner layer may be provided (particularly preferably lined) with an anchor layer.

However, additional layers can also be added.

The steps do not have to be performed in the sequence of the order in which they are mentioned.

In step c., the cuts can be made during the laying of a non-crimp fibre fabric or even later when a material sheet has already been formed from the scrim. The cuts can be made by mechanical knives, shears, but also lasers or ultrasonic knifes.

In another embodiment, the object of the invention is achieved by the use of the liner according to the invention for the rehabilitation of pipelines or canals.

In another embodiment, the object of the invention is achieved by a process for rehabilitating pipelines or canals, characterised in that a liner according to the invention is introduced into a pipeline or canal to be rehabilitated and the liner is cured in the pipeline or canal. Curing can be performed with UV light or thermally.

In another embodiment, the object of the invention is achieved by a rehabilitated pipeline or canal characterised in that the pipeline or canal has a (cured or uncured) liner according to the invention.

### BRIEF DESCRIPTION OF THE DRAWINGS

In the following, the figures are described. This description addresses concrete and preferred embodiments of the invention which do not limit the invention.

FIG. 1 shows a liner 10 with the various layers in cross-section.

FIG. 2 shows an additional material sheet 90 from which the transverse fibrous layer 30 is formed.

### DETAILED DESCRIPTION

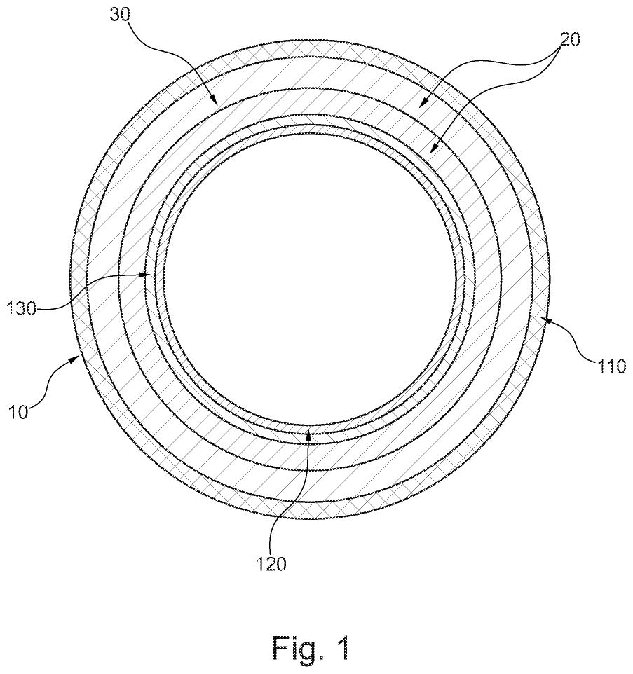

FIG. 1 shows a liner 10 with an exterior layer 110, the fibrous layers 20, wherein the outer fibrous layer thereof is a transverse fibrous layer 30. The inner layer 120 can be a polymer film lined with an anchor layer 130 such as a polyester nonwoven fabric, for example, on its inner surface.

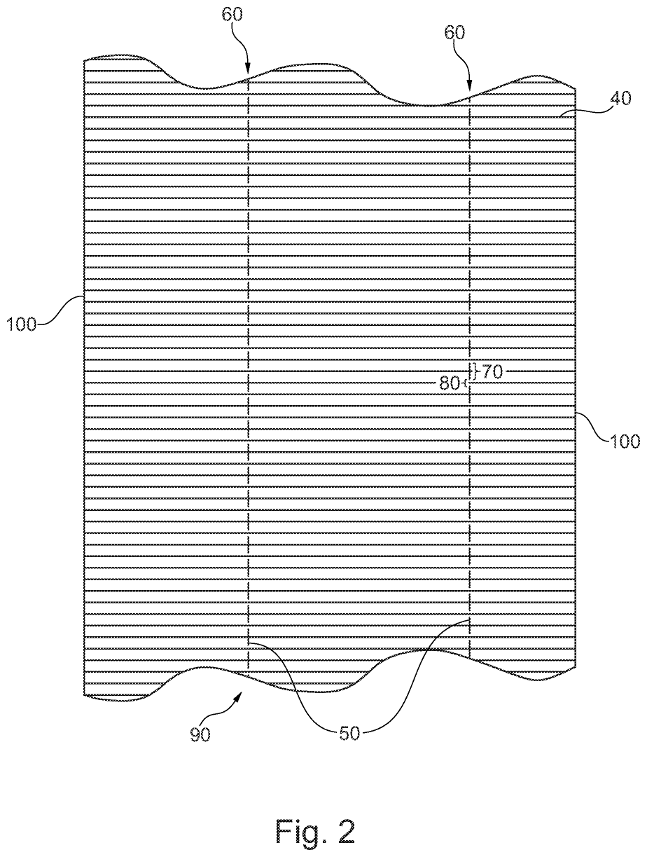

FIG. 2 shows the additional material sheet 90. A tubular transverse fibrous layer 30 is formed from the additional material sheet 90 by connecting the longitudinal edges 100. Said transverse fibrous layer is arranged at the extreme outside, for example. Once the longitudinal edges have been laid on top of each other in an overlapping manner, they can be connected by needle punching. The fibres of the transverse fibrous layer 40 are severed by cuts 50 along cutting lines 60. The cutting length 70 is longer than the spacing 80. The cuts 50 of the various cutting lines 60 are arranged offset such that the fibres of the transverse fibrous layer 40 are severed at least once in any case.

### Exemplary Embodiment

The liners or lining hoses can be obtained by processes known as such and described in literature. If the process is not specifically described hereinbelow, it can be assumed that a person skilled in the art will subsequently follow the processes known as such and in the literature.

On a scrim line 300 cm in width, direct roving strands (continuous fibres, 0 degree material) made of glass fibre with a total weight per unit area of 600 g/m² and spaced 1 cm apart were introduced in the longitudinal direction. Glass fibres with a total weight per unit area of 600 g/m² were evenly placed thereon at an angle of 90 degrees (90 degrees material). In this stage of manufacturing this 90 degrees material still has a length of 300 cm, that is, the width of the scrim. Chopping roving (CSM) with a total weight per unit area of 600 g/m² was randomly arranged thereon such that the individual fibre sections of the chopping roving were oriented in all possible directions. The chopping roving was obtained by cutting the direct roving into sections having a length of 10 cm. Subsequently, the three fibrous layers were sewn with polyester yarn to form a mat.

Another mat was manufactured in the same way.

Then, one of the obtained sheets was cut in the longitudinal direction by rotating knives. This was achieved by fitting rotating knives 20 cm apart which penetrated the traversing web on the side of the direct roving at regular intervals such that they made cuts in the 90 degrees material with a length of approximately 10 cm and in a distance of 5 cm between each other along a cutting line. The rotating knives were adjusted to ensure that adjacent rotating knives made a cut in the 90 degrees material whenever the adjacent rotating knife was kept outside the mat for the 5 cm distance. This ensured that each fibre of the 90 degrees material was cut several times. In this way the transverse fibrous layer was obtained.

Hence, one mat containing a cut 90 degrees material and one mat containing uncut 90 degrees material were provided. A polymer hose was introduced into a device for manufacturing the dry material. This polymer hose substantially consisted of a polymer and had a diameter of 85 cm. However, it also comprised a conventional styrene barrier (PE/PA/PE). The uncut mat was arranged around this hose such that it overlapped at the longitudinal edges, there was no excessive play between the polymer hose and the mat and such that the direct roving was arranged adjacent to the hose. Then, the second mat containing the cut 90 degrees product was laid around the first mat such that the direct roving was arranged at the outside. The longitudinal edges overlapped such that the mat could be laid around the first mat without any excessive play and needle-punched in the overlapping area. The resulting dry material was impregnated with a UP resin usually used for liners for canal rehabilitation which contained a photoinitiator. Subsequently, a hose such as the internal polymer hose comprising a styrene barrier was drawn around the impregnated liner. A conventional grey mechanically stable exterior film impermeable to light and UV radiation was drawn as the last layer.

Using common methods, a sewer having a diameter of 950 mm could be rehabilitated with the resulting liner for canal rehabilitation by inserting the liner into the sewer, inflating and curing it with UV light.

### REFERENCE SYMBOLS

10 Liner
20 Fibrous layers
30 Transverse fibrous layer
40 Fibres of the transverse fibrous layer
50 Severings or cuts
60 Cutting lines
70 Cutting length
80 Spacing
90 Additional material sheet for providing the transverse fibrous layer
100 Longitudinal edges of the material sheet
110 Exterior layer
120 Inner layer
130 Anchor layer

What is claimed is:

1. A tubular liner for rehabilitation of pipelines or canals containing resin-impregnated fibrous layers, wherein at least one of the resin-impregnated fibrous layers is a transverse fibrous layer which mainly comprises fibres arranged at an angle in a range from 45 degrees to 135 degrees with respect to the longitudinal direction of the tubular liner, wherein the fibres of the transverse fibrous layer arranged in this way have a median length in a range from 10 to 55% of the circumference of the tubular liner.

2. The tubular liner according to claim 1, wherein the transverse fibrous layer mainly comprises fibres arranged at an angle in a range from 80 degrees to 100 degrees with respect to the longitudinal direction of the tubular liner.

3. The tubular liner according to claim 1, wherein the at least one transverse fibrous layer mainly comprises fibres extending longitudinally essentially around the circumference of the liner, which, however, are severed at least one point.

4. The tubular liner according to claim 3, wherein the severings are grouped and the positions in the circumferential direction of the severings of groups of severings adjacent in the longitudinal direction of the tubular liner have distances of from 10% to 40% of the circumference of the tubular liner.

5. The tubular liner according to claim 1, wherein the fibres of the transverse fibrous layer are severed by cuts in the longitudinal direction of the tubular liner having a length of from 0.5 to 50 cm, respectively.

6. The tubular liner according to claim 1, wherein the severings extend along one or several cutting lines arranged in the longitudinal direction of the tubular liner.

7. The tubular liner according to claim 6, wherein adjacent cuts having a cutting length are spaced from each other by one spacing and the median of the spacing of the cuts along one cutting line is shorter than the median of the cutting length of the cuts and the median of the spacing is in a range from 20 to 70% of the median of the cutting length.

8. The tubular liner according to claim 1, wherein the outermost fibrous layer is a transverse fibrous layer.

9. A cured liner, wherein a resin system of the resin-impregnated liner according to claim 1 is cured.

10. A process for manufacturing the tubular liner according to claim 1, wherein the process comprises at least:
a. providing at least one material sheet containing fibres for manufacturing a fibrous layer;
b. providing at least one additional material sheet for manufacturing a transverse fibrous layer which mainly comprises fibres arranged at an angle in a range from 45 degrees to 135 degrees with respect to the longitudinal direction of the material sheet, wherein the fibres arranged in such a way are mainly as long as the material sheet is wide;
c. making longitudinal cuts in the additional material sheet, wherein the fibres of the additional material sheet are severed such that said fibres of the additional material sheet arranged at the above-mentioned angle mainly have a median length in a range from 25 to 50% of the width of the material sheet;
d. connecting the longitudinal edges of at least one of the material sheets such that this material sheet becomes a tubular fibrous layer, wherein the additional material sheet becomes the transverse fibrous layer and the formed tubular fibrous layers are arranged in one another; and
e. impregnating the fibrous layers with a resin system.

11. A method of using the tubular liner according to claim 1 for the rehabilitation of the pipelines or canals.

12. A process for rehabilitating pipelines or canals, wherein the tubular liner according to claim 1 is introduced into the pipeline or canal and the tubular liner is cured in the pipeline or canal.

13. A rehabilitated pipeline or rehabilitated canal, wherein the pipeline or canal comprises the cured liner according to claim 9.
